(19) United States
(12) Patent Application Publication
(10) Pub. No.: US 2014/0289660 A1
(43) Pub. Date: Sep. 25, 2014

(54) METHOD AND APPARATUS FOR CONVERTING OBJECT IN PORTABLE TERMINAL

(71) Applicant: Samsung Electronics Co., Ltd., Suwon-si (KR)

(72) Inventor: Kyeongwook MIN, Gumi-si (KR)

(73) Assignee: Samsung Electronics Co., Ltd., Suwon-si (KR)

(21) Appl. No.: 14/217,975

(22) Filed: Mar. 18, 2014

(30) Foreign Application Priority Data
Mar. 22, 2013 (KR) 10-2013-0030701

(51) Int. Cl. G06F 3/0484; G06F 3/0482; G06F 3/0481

(52) U.S. Cl. CPC G06F 3/04842; G06F 3/04817; G06F 3/0482
USPC 715/765

(57) ABSTRACT

A method of converting an object in a portable terminal is provided. The method includes displaying a first object corresponding to an application on a standby screen of the portable terminal, detecting a first touch input of a user selecting the first object, changing an operating mode of the portable terminal from a standby mode to an object conversion mode if the first touch input is an input requesting entry to an object conversion mode, detecting a conversion request for a first object in the object conversion mode, and detecting a second touch input of a user selecting the second object, and changing the first object to a second object in response to the second touch input.

### CROSS-REFERENCE TO RELATED APPLICATION(S)

This application claims the benefit under 35 U.S.C. §119(a) of a Korean patent application filed on Mar. 22, 2013 in the Korean Intellectual Property Office and assigned Serial number 10-2013-0030701, the entire disclosure of which is hereby incorporated by reference.

### TECHNICAL FIELD

The present disclosure relates to a method and a device for converting an object in a portable terminal More particularly, the present disclosure relates to a method and a device for converting an object in a portable terminal, which supports an interactive converting function between a plurality of objects output on a screen of a portable terminal in correspondence with a single application.

### BACKGROUND

According to a recent development of a communication technology, a portable terminal, for example, a smart phone and a tablet Personal Computer (PC), is widely used. The portable terminal is used in various fields due to convenience in use and portability. Particularly, a portable terminal including a touch screen has been recently continuously developed. The portable terminal including the touch screen that provides various functions, such as video reproduction and document writing, in addition to communication services. The recently generalized portable terminals output an object, for example, an icon or a widget, corresponding to an application (hereinafter, the “app”) that is displayed on a screen. Users of the portable terminals select a specific object output on the screen, and activate and use a desired function of the portable terminal.

However, various types of objects may be included with a single application. Here, the object may be classified into an icon expressed by a static image according to a difference in indication information, and a widget may be expressed by a dynamic image. Companies that manufacture the portable terminal provide a function of converting the object so that an icon or a widget is output on a screen according to a preference of a user.

In the meantime, the object converting function in the related art is performed by removing an object output on a screen and regenerating the object. For example, when a user desires to convert a calendar app icon into a calendar app. widget, the user first deletes the calendar app icon output on the screen. Next, the user enters a widget generating menu and selects a specific app, that is, the calendar app, for a widget to be generated. When the calendar app widget is output on the screen, the user selects the output calendar app widget so that the calendar app icon may be converted into the calendar app widget. That is, in order to re-generate the icon or the widget of the deleted app, the user needs to remember the type of deleted application and needs to inconveniently generate the icon or the widget of the deleted app through a burdensome process. As the number of functions provided by the portable terminal has been recently increased, it is difficult for the users to convert an icon or a widget having a desired characteristic. Accordingly, a user interface through which a user may more easily use an interactive converting function between an icon and a widget corresponding to the single application has been demanded.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a device for converting an object in a portable terminal, which supports interactive conversion between icons or widgets to a form desired by a user.

In accordance with an aspect of the present disclosure, a method of converting an object in a portable terminal is provided. The method includes displaying a first object corresponding to an application on a standby screen of the portable terminal, detecting a first touch input of a user selecting the first object, changing an operating mode of the portable terminal from a standby mode to an object conversion mode if the first touch input is an input requesting entry to an object conversion mode, detecting a conversion request for a first object in the object conversion mode, and changing the first object to a second object in response to the conversion request.

In accordance with another aspect of the present disclosure, a portable terminal is provided. The portable terminal includes a touch screen configured to detect a touch input of a user and to provide a user interface for converting an object output on a standby screen, and a controller configured to control the touch screen to detect a first touch input for a first object displayed corresponding to an application on the touch screen, change an operating mode of the portable terminal from a standby mode to an object conversion mode when the first touch input is an input requesting entry to the object conversion mode, and change the first object to a second object in response to a conversion request.

According to various embodiments of the present disclosure, it is possible to rapidly and conveniently interactively convert an icon and a widget corresponding to a single application in a desired form on a screen of a portable terminal

Further, according to various embodiments of the present disclosure, it is possible for a user to convert a specific object to an object having a desired form of characteristic according to a preference of a user without memorizing application information corresponding to an icon or a widget.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a portable terminal according to an embodiment of the present disclosure;

FIG. 2 is a flowchart illustrating a method of converting an object in the portable terminal according to an embodiment of the present disclosure;

FIG. 3 is a view of a screen for describing an object converting function according to a first embodiment of the present disclosure;

FIG. 4 is a view of a screen for describing an object converting function according to a second embodiment of the present disclosure;

FIG. 5 is a view of a screen for describing an object converting function according to a third embodiment of the present disclosure;

FIG. 6 is a view of a screen for describing an object converting function according to a fourth embodiment of the present disclosure; and

FIG. 7 is a view of a screen for describing an object converting function according to a fifth embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modification of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An “object” in the present disclosure refers to an object in which a command for executing a corresponding application is expressed by an image. The object may be classified into an icon and a widget according to output indication information. Here, the icon is an object in which a command for executing an application by a static image, and the widget refers to an object which simultaneously supports a command for executing an application and a function of displaying execution information related to the corresponding application, and in which the command and the function are expressed by a dynamic image.

A method and a device for converting the object according to the present disclosure may be applied to a portable terminal The portable terminal may include a mobile phone, a smart phone, a tablet Personal Computer (PC), a hand-held PC, a Portable Multimedia player (PMP), a Personal Digital Assistant (PDA), and the like. In the following description, the present disclosure will be described on an assumption that a method and a device for converting an object are applied to the portable terminal

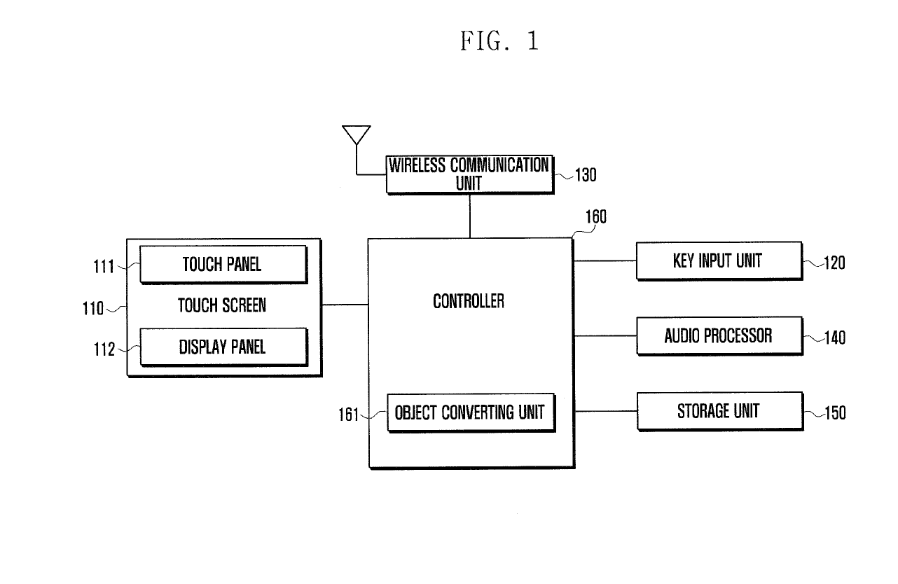

FIG. 1 is a block diagram of a portable terminal according to an embodiment of the present disclosure.

Referring to FIG. 1, a portable terminal 100 according to the present disclosure may include a touch screen 110 including a touch panel 111 and a display unit 112, a key input unit 120, a wireless communication unit 130, an audio processor 140, a storage unit 150, and a controller 160.

The touch screen 110 may include the touch panel 111 and the display unit 112. The touch panel 111 is placed on the display unit 112. Particularly, the touch panel 111 may be implemented by an add-on type, in which the touch panel 111 is positioned on a front surface of the display unit 112, or an on-cell type or an in-cell type in which the touch panel 111 is inserted into the display unit 112.

The touch panel 111 generates an analog signal (for example, a touch event) in response to user input information (for example, user's gesture) on the touch panel 111. An Analog-to-Digital Converter (ADC) (not shown) converts the generated analog signal and transmits the converted analog signal to the controller 160. Here, the touch event includes information about touch coordinates (X, Y). When the touch event is received from the touch screen 110, the controller 160 determines that a touch means (for example, a finger or a pen) touches the touch screen 110, and when the touch event is not received from the touch screen 110, the controller 160 determines that the touch is released. Further, in a case where the touch coordinates are changed, the controller 160 determines that the touch moves and calculates the amount of position movement of the touch, a moving speed of the touch, and the like in response to the movement of the touch. The controller 160 classifies a user's gesture based on the touch coordinates, whether the touch is released, whether the touch moves, the amount of position change of the touch, a moving speed of the touch, and the like. The user's gesture may include a touch, a multi-touch, a tap, a double tap, a long tap, a tap & touch, a drag, a flick, a press, a long press, a pinch-in, and a pinch-out. Further, the touch screen may include a pressure sensor to detect a pressure at a touched point. Information about the detected pressure is transmitted to the controller to be classified into a touch and a press. The touch panel 111 may be implemented by a resistive sensor, a capacitive sensor, and an electromagnetic induction sensor.

The display unit 112 converts image data provided from the controller 180 into an analog signal and displays the converted analog signal. That is, the display unit 112 may provide various screen images, for example, a lock screen image, a home screen image, an application (hereinafter, referred to as an “app”) execution screen image, a keypad screen image, a message writing screen image, and an Internet screen image, according to use of the portable terminal The lock screen image is a screen image displayed on the display unit 110 when the display unit is locked. When a touch input or a key input for releasing the lock is detected, the controller controls the display unit so as to display the home screen image or the app execution screen image, instead of the lock screen image. The home screen image may include a background image and a plurality of objects that are displayed on the background image. Here, the objects correspond to respective apps that provide various functions to the portable terminal. When any one of the objects is selected by the user (for example, the object is tapped), the controller 160 executes a corresponding app (for example, a picture app), and displays an execution screen image of the corresponding app on the display unit 110. The screen 112 may be used in a form of a flat panel display unit, such as a Liquid Crystal Display (LCD), an Organic Light Emitting Diode (OLED), and an Active Matrix Organic Light Emitting Diode (AMOLED).

The display unit 112 in the present disclosure may output a screen image according to entering an object conversion mode in change indication information of the object. Particularly, the portable terminal in the present disclosure supports converting an object output on the screen to another type of object. The display unit 112 may output a list of objects that have indication information different from that of the object output on the screen. That is, when a conversion request event for a specific object is detected, the controller 160 outputs the list of the objects (e.g., a widget and an icon) supportable by a corresponding app on the display unit. The user may select an object in the list, which is to be converted and displayed in correspondence with the selected object, through the list. The controller 160 may control so as to output and display the selected object.

The key input unit 120 may include a plurality of input keys and function keys for receiving number or character information and setting various functions. The function keys may include direction keys, a side key, and a shortcut key set to perform a specific function. Further, the key input unit 120 generates a key signal related to user setting and function control of the portable terminal 100 and transmits the generated key signal to the controller 160. The key signal may include a power on/off signal, a volume adjusting signal, a screen on/off signal, and the like. The controller 160 may control the elements in response to the key signal. Further, the key input unit 120 may be configured as a QWERTY keypad, a 3*4 keypad, and a 4*3 keypad and include a plurality of supplemental keys. Further, when the touch panel 111 of the portable terminal 100 is supported in a type of a full touch screen, the key input unit 120 may include at least one side key for screen on/off, portable terminal on/off, and the like, that may be formed at a lateral side of a case of the portable terminal 100.

The wireless communication unit 130 forms a communication channel with a wireless communication network to perform a communication function of the portable terminal The wireless communication unit 130 may include a wireless frequency transmitter for up-converting and amplifying a frequency of a transmitted signal, and a wireless frequency receiver for low-noise amplifying and down-converting a frequency of a received signal. Further, the wireless communication unit 130 may include a mobile communication module (for example, a 3^{rd}-Generation mobile communication module, a 3.5^{th}-generation mobile communication module, or a 4^{th}-Generation mobile communication module), and a Digital Multimedia Broadcasting (DMB) module, for example.

Particularly, the wireless communication unit 130 of the present disclosure may perform data communication between an external server or another portable terminal and a specific channel, and may periodically or temporarily receive specific data based on the specific channel. In this case, the specific data received by the wireless communication unit 130 may be data applied to the widget output on the display unit 112. For example, in a case where the widget is a widget corresponding to a weather app, the specific data may be weather information received from the specific server in real time. Further, in a case where the widget is a widget corresponding to a stock app, the specific data may be stock information periodically received from the server. When the controller 160 receives the specific data from the wireless data, the controller 160 may provide the received specific data to the specific widget and change indication information that is being output on the screen.

The audio processor 140 converts audio data, such as a voice, input from the controller 160 using a Digital-to-Analog Converter (DAC) and transmits the converted data to a speaker SPK. The audio processor 140 converts audio data, such as a voice, input from a microphone MIC into a suitable digital form using an ADC and transmits the converted data to the controller 160.

The storage unit 150 may store various data generated in the portable terminal, an Operating System (OS) of the portable terminal 100, and various applications. The data may include application data that is generated during the execution of an application and all of the storable types of data that is generated by using the portable terminal or received from the outside (for example, an external server, another portable terminal, and a personal computer). The storage unit 150 may store a user interface provided by the portable terminal and various setting information for processing a function of the portable terminal. In the present disclosure, the storage unit 150 may store icons or widgets in different types, that is, different arrangements of indication information, corresponding to a single app according to the function of the portable terminal

The controller 160 controls a general operation of the portable terminal 100 and a signal flow between the internal elements of the portable terminal 100, and performs a function of processing data. The controller 160 controls a power supply from a battery to the internal elements. When the power is supplied, the controller 160 performs a booting process and executes various application programs of the portable terminal 100 according to the setting of the user.

The controller 160 determines whether an input of the user of selecting the object output on the screen is an object conversion request event. When the input is the object conversion request event, the controller 160 changes an operating mode to an object conversion mode that is capable of converting an object selected in a standby mode. The controller 160 controls signal processing for converting a specific object into another type of object in the object conversion mode state.

The controller 160 may include an object converting unit 161. The object converting unit 161 changes the object output on the touch screen into an object having different indication information or information in a different arrangement from that of the output object and outputs the changed object. When a specific touch event such as a long press is generated on the touch panel, the object converting unit 161 controls to enter the object conversion mode. The object converting unit 161 collects information about objects formed in different types from that of the specific object corresponding to the app. In the present disclosure, in the portable terminal 100, the specific app (e.g., a weather app, a stock app, a message app, a clock app, a calendar app, a radio app, a cashbook app, and a news app) provides a plurality of objects having various types of display form. For example, in a case of a weather app, a weather app icon and a weather widget are provided. The weather widget may have various types of display forms for each size, such as 1*2, 2*2 and 4*4. Here, the indication information or disposition position of the output information may be changed.

When the object conversion request event is detected, the object converting unit 161 controls the object conversion mode entrance. The object converting unit 161 may output a mode effect for displaying the object conversion mode entrance on the display unit. For example, the object converting unit 161 separately output a display region in which the specific object selected by the user is disposed, and a menu region including a conversion item and a deletion item. Further, the object converting unit 161 may process the display region to have a shadow or to be shaded, and control so that only the specific object selected on the screen is movable. When a movement position of the specific object moves to the position of the conversion item of the menu region, the object converting unit 161 may output a list of objects having different indication information from that of the corresponding object. Further, the object converting unit 161 may store a position point at which the specific object is disposed, and output the converted object at the stored position point.

Hereinafter, a particular function of the controller according to the present disclosure will be described in detail below.

According to a convergence trend of a digital device, the digital device is varies so that it is impossible to enumerate all configurations of the digital devices, but the portable terminal 100 according to the present disclosure may further include any suitable elements such as a sensor module for detecting information related to a position change of the portable terminal, a Global Positioning System (GPS) module for measuring a position of the portable terminal 100, and a camera module. Further, specific elements of the portable terminal 100 of the present disclosure may be excluded or be replaced with other elements as a matter of course. Further, the input unit in the present disclosure may be a touch pad, a trackball, and the like, in addition to the touch screen 110 and the key input unit 120.

Further, an operation of the controller in the present disclosure will be described based on a touch event among various input signals of the portable terminal However, the operation for converting the object in the present disclosure is not limited to the touch event signal. That is, the operation of the controller may be performed by signals input from various devices capable of generating an input signal.

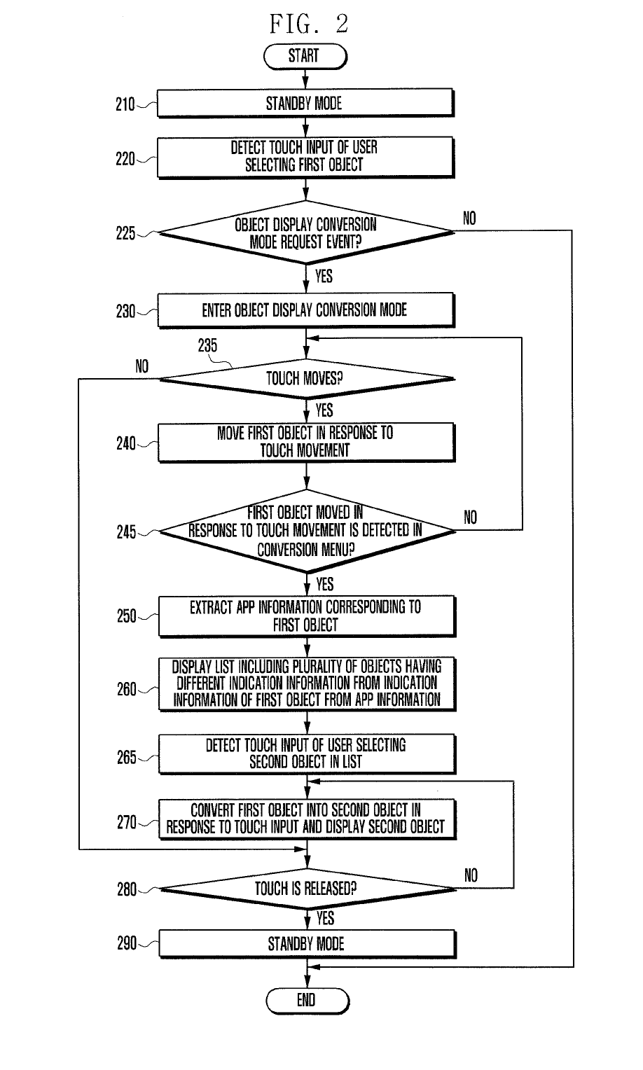

FIG. 2 is a flowchart illustrating a method of converting an object in the portable terminal according to an embodiment of the present disclosure.

Referring to FIG. 2, in operation 210, the controller 160 may be first operated in a standby mode, which is waiting for an input of the user. In the standby mode, the controller 160 may display a screen image including a plurality of objects (icons or widgets) on the touch screen 110.

In operation 220, the controller 160 may detect a touch input of a user selecting a first object among a plurality of objects. Here, the first object may be an icon or a widget.

In operation 225, the controller 160 determines whether the touch input of the user exceeds a preset time. Here, the preset time is a time set for conversion mode entrance of the object (for example, 2 seconds or longer), and may be set during manufacturing of the portable terminal or set by the user, but is not limited thereto. When the touch input of the user selecting the first object exceeds the preset time, the controller 160 may recognize the touch input as a signal requesting a display conversion of the first object. Here, the touch input of the user selecting the first object exceeds the preset time is described as an example, but the present disclosure is not limited thereto and may be changed according to the setting, such as a multi tap or a multi long tap.

In operation 230, when the touch input of the user exceeds the preset time, the controller 160 changes the operating mode from the standby mode to the object conversion mode. In the object conversion mode, the controller 160 outputs a control screen image for converting a display of the selected first object. Particularly, when the time of the touch input of the user selecting the first object exceeds the preset time, the controller 160 determines to change the operating mode to the object conversion mode. On the other hand, when the touch input does not exceed the preset time, the controller 160 determines to output an execution screen image of the app corresponding to the selected object.

When in the object conversion mode, the controller 160 may output an object conversion menu item. For example, the touch screen 110 may output the display region displaying the object selected by the touch input of the user, the menu region including the conversion item, and the deletion item in the object conversion mode. Further, the controller 160 may move the first object selected by the touch input in response to a touch gesture.

In operation 235, the controller 160 determines whether a touch movement is detected. In operation 240, when the touch movement is detected, the controller 160 moves the first object in response to the touch movement. That is, the touch screen 110 displays the movement of the object under the control of the controller 160.

In operation 245, the controller 160 determines whether the movement of the first object is detected at a menu item position of the conversion item. In operation 250, when the controller 160 determines that the first object moves to the position of the conversion item, the controller 160 identifies app information corresponding to the selected first object and collects information of an object having different indication information from that of the first object.

In operation 260, the controller 160 outputs a selection list of the plurality of objects that have different indication information from that of the first object on the touch screen 110. Particularly, when the first object is an icon, the controller 160 may output a selection list that includes a plurality of widgets for differently displaying the indication information. Here, the icon is a static image which does not display the app execution information and the widget corresponds to a dynamic image that displays the app execution information. Further, the widgets supportable by the portable terminal according to the present disclosure differently display the app execution information according to the form of the widget. That is, the selection list may include a first widget displaying the app execution information in a first form, a second widget displaying the app execution information in a second form that is from that of the first widget, a third widget displaying the app execution information in a third form that is different from the first widget and the second widget, a fourth widget, and the like. Further, when the first object is the first widget, the controller 160 may display a list that includes the icon corresponding of the app, the second widget displaying the app execution information in the second different form, the third widget, and the like. For example, the widgets corresponding to the clock app will be described. The widgets may be classified into a plurality of types according to app execution information and a size. That is, the portable terminal according to the present disclosure may provide various types, such as a digital clock widget having a size of 4*1 in correspondence with the clock app, a digital clock widget having a size of 2*1, an analog clock widget having a size of 2*2, and a modem clock widget having a size of 2*2. Further, in the present disclosure, a plurality of different icons may be displayed in the object conversion display mode, such as a first type icon and a second-type icon, may also be provided.

Further, the selection list provided in the present disclosure may be provided by including objects, that is, icons and widgets, supportable by the corresponding app by confirming app information corresponding to the first object.

The terminal in the present disclosure may provide a plurality of objects having different indication information corresponding to the specific object, but may provide only one object. For example, when the radio execution objects supports only one radio icon and one radio widget, operation 260 may be omitted. In this case, when the controller 160 determines that the first object moves to the position of the conversion item, the controller 160 may change the first object to a second object having different indication information and display the second object. In operation 265, the controller 160 may detect an input of the user selecting a specific type of object in the selection list. In operation 270, when the specific type of object is selected in the selection list, the controller 160 converts the first object to the second object and displays the converted second object on the touch screen 110. Here, the controller 160 may display the selected object in a preview type, but is not limited thereto.

In operation 280, the controller 160 determines whether a touch release is generated during the display of the second object in the preview type.

In operation 290, when the touch release is generated, the controller 160 changes the operating mode from the object conversion mode to the standby mode in response to the touch release and outputs the second object on the standby screen. In this case, the controller 160 may display the second object based on the point at which the first object is output on the touch screen. Otherwise, before the touch release is detected, the controller 160 may detect a touch movement during the display of the second object and move the position of the second object based on the touch movement. In this case, the controller 160 may output the second objects on the standby screen based on a point at which the touch is released.

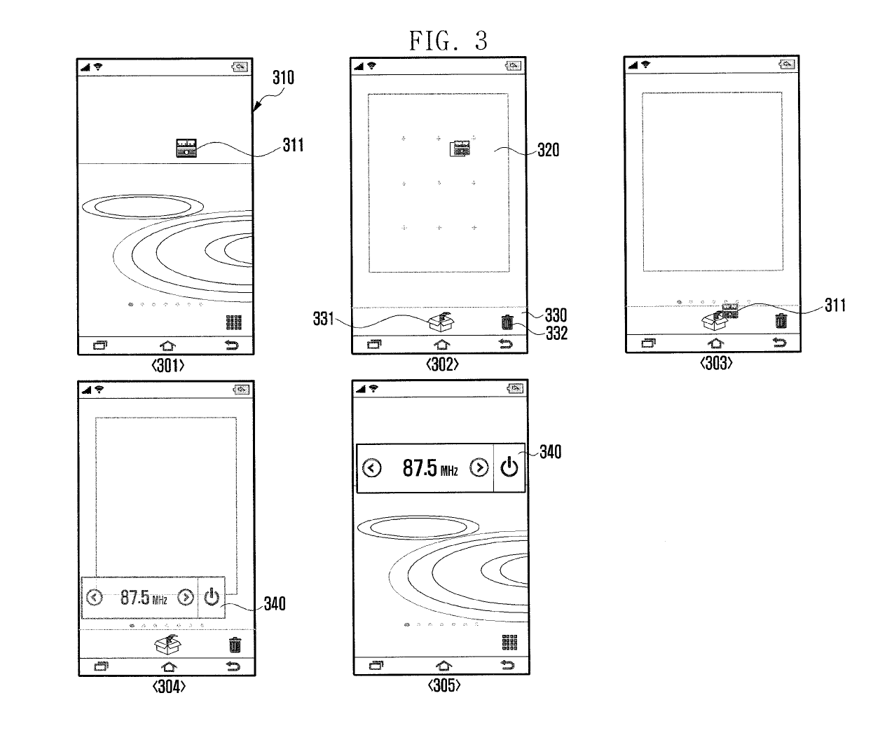

FIG. 3 is a view of a screen for describing an object converting function according to a first embodiment of the present disclosure.

Referring to FIG. 3, the touch screen 110 displays a radio app icon 311 corresponding to a radio app on a standby screen 310 as illustrated in screen 301 of FIG. 3. In the embodiment of the present disclosure, the controller 160 may display a plurality of objects on the standby screen 310.

A user may select the radio app icon 311 in order to convert the radio app icon 311. The controller 160 detects a touch of selecting the radio app icon 311 and counts a time based on a touch detection time point. When the touch of selecting the radio app icon 311 is maintained for a preset time (for example, 2 seconds) or longer without a change in position, the controller 160 changes the operating mode from the standby mode to the object conversion mode. The controller 160 determines the radio app icon 311 as an object conversion target object and displays the radio app icon 311 in a movable state. In the object conversion mode, the touch screen 110 may be divided into a display region 320 in which the selected radio app icon 311 is displayed and a menu region 330 in which conversion menu items are displayed to be displayed as illustrated in screen 302. The menu region 330 may include an object conversion item 331 and a deletion item 332, but is not limited thereto.

The user may drag and move the radio app icon 311 to the conversion item in a state where the user touches the radio app icon 311 as illustrated in screen 303. The controller 160 detects a movement of the touch on the touch screen 110 and displays the movement of the radio app icon 311 in response to the movement of the touch.

When the controller 160 detects that the radio app icon 311 is positioned at the object conversion item, the controller 160 outputs a radio app widget 340 for providing different indication information from that of the radio app icon 311 on the display region 320 as illustrated in screen 304. For example, in the embodiment of the present disclosure, a case in which the number of widgets supportable by the radio app is one is described as an example, but the present disclosure is not limited thereto, and in a case where the number of widgets supportable by the radio app is plural, the present disclosure may output a selection list including the plurality of widgets.

The user may tap the output radio app widget 340. Then, the controller 160 detects a touch event according to the tap gesture of the user, and changes the operating mode from the object conversion mode to the standby mode. The controller 160 outputs the radio app widget 340 as illustrated in screen 305. Here, the radio app widget 340 may be output at a position of a point at which the radio app icon is output.

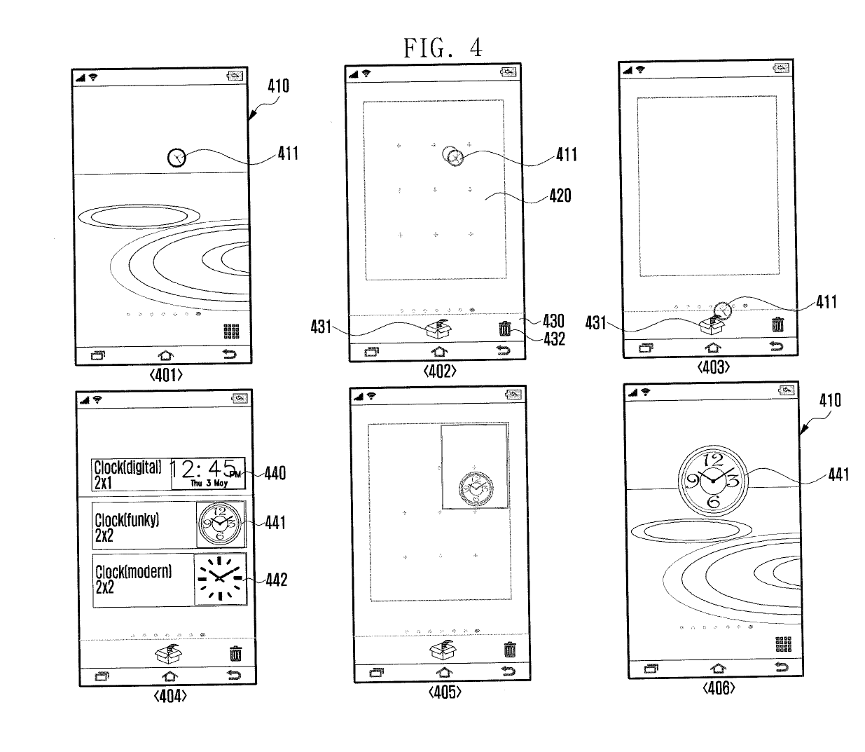

FIG. 4 is a view of a screen for describing an object converting function according to a second embodiment of the present disclosure.

Referring to FIG. 4, the touch screen 110 may display a standby screen 410 as illustrated in screen 401 of FIG. 4. The standby screen 410 may display an object corresponding to at least one app. For example, as illustrated in screen 401, the touch screen 110 displays a clock icon 411 corresponding to a clock app on the standby screen 410. Here, the clock icon 411 refers to an object expressing a command for executing a clock application with a static image. When the user selects the clock icon output on the screen, the controller 160 outputs an execution screen image of the clock application on the screen.

The user may touch the clock icon 411 displayed on the standby screen 410. The controller 160 detects a touch of selecting the clock icon 411 and counts a time based on a touch detection time point. When the touch of selecting the clock icon 411 is maintained for a preset time (for example, 2 seconds) or longer without a change in a position, the controller 160 changes the operating mode from the standby mode to the object conversion mode. That is, the controller 160 determines the clock icon 411 as a conversion target object and changes the standby screen to an object conversion mode screen image in order to control so that the clock icon is movable. In the object conversion mode, the touch screen 110 may be divided into a display region 420 in which the selected clock icon is displayed and a menu region 430 in which conversion menu items are displayed as illustrated in screen 402. The menu region 430 may include an object conversion item 431 and a deletion item 432, but is not limited thereto.

The user may move the clock icon 411 to the conversion item 431 in a state where the user touches the clock icon 411 as illustrated in screen 403. Then, the controller 160 detects a movement of the touch on the touch screen 110. The controller 160 moves the clock icon 411 to the conversion item 431 in response to the movement of the touch. That is, the touch screen 110 displays the movement of the object under the controller 160. For example, when the user drags and moves the clock icon 411 to the conversion item, the controller 160 detects that the clock icon 411 is positioned at the conversion item 431 and collects widget information supportable by the portable terminal in correspondence with the clock app.

That is, the controller 160 confirms clock app information corresponding to the clock icon 411 and outputs a widget selection list of the objects providing different indication information from that of the clock icon 411 on the touch screen 110. For example, the touch screen 110 displays a list including the widgets providing different indication information from that of the clock icon such as a first widget 440 displaying clock app information in a first type, a second widget 441 displaying clock app information in a second type, and a third widget 442 displaying clock app information in a third type, as illustrated in screen 404.

In this state, the user may select the second widget 441. Then, the controller 160 detects an input of the user selecting the second widget 441, converts the clock icon to the second widget 441, and displays the second widget 441 on the display region 420 as illustrated in screen 405. In this case, the controller 160 may display the second widget 441 in a preview type in the object conversion mode, but the present disclosure is not limited thereto. The second widget 441 may be output at a position of a point at which the clock icon is output, but is not limited thereto.

In this state, the user may release the touch. The controller 160 changes from the object conversion mode to the standby mode in response to the release of the touch and outputs the second widget 441 displaying the clock app execution information on the standby screen 410 as illustrated in screen 406. Further, the controller 160 may detect a movement of the touch of the user moving the second widget 441 before the release of the touch. When the user moves the second widget 441, the second widget 441 may output on the standby screen 410 based on a point at which the touch is released.

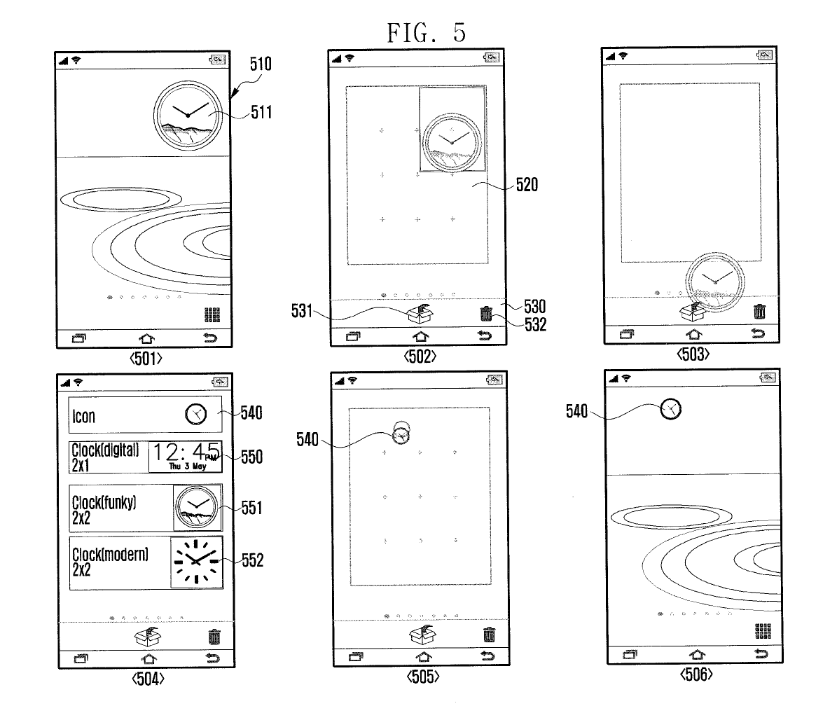

FIG. 5 is a view of a screen for describing an object converting function according to a third embodiment of the present disclosure.

Referring to FIG. 5, the touch screen 110 displays a first clock app widget 511 corresponding to a clock app on a standby screen 510 as illustrated in screen 501 of FIG. 501. The first clock app widget 511 displays time information according to elapse of a time on an image.

In order to convert the first clock app widget 511, the user may select the first clock app widget 511. When a touch of selecting the first clock app widget 511 is maintained for a preset time (for example, 2 seconds) or longer without a change in a position, the controller 160 changes from the standby mode to the object conversion mode. The controller 160 determines the first clock app widget 511 as an object conversion target object. In the object conversion mode, the touch screen may be divided into a display region 520 in which the first clock app widget 511 is displayed and a menu region 530 in which conversion menu items are displayed as illustrated in screen 502. The menu region 530 may include an object conversion item 531 and a deletion item 532, but is not limited thereto.

In screen 503, the user may drag and move the first clock app widget 511 to the conversion item 531.

The controller 160 determines that the first clock app widget 511 moves to a position of the conversion item 531 and outputs a selection list of the objects that are supportable by the portable terminal in correspondence with the clock app as illustrated in screen 504. For example, as illustrated in screen 504, the controller 160 may output the selection list including a clock icon 540 corresponding to the clock app, a widget 551 having the same indication information as that of the first clock app widget, a second clock app widget 552, a third clock app widget, a fourth clock app widget 550 having indication information in a different type from that of the first clock app widget, and the like on the screen. In a case of FIG. 5, the selection list including all of objects that are supportable by the portable terminal.

In this state, in a case where the user selects the clock app icon 540, the controller 160 converts the clock app widget 511 to the clock app icon 540 and displays the converted clock app icon 540 on the display region 520 as illustrated in screen 505. The clock app icon displayed in the display region 520 is output in a preview type, but is not limited thereto.

The user may release the touch in a state where the clock app icon 540 is output in the display region 520. The controller 160 changes from the object conversion mode to the standby mode in response to the release of the touch and outputs the clock app icon 511 on the standby screen 510. Here, the clock app icon 511 may be output at a position of a point at which the clock app widget is output. Particularly, the controller 160 may output the converted object based on a center point of the object when converting the object.

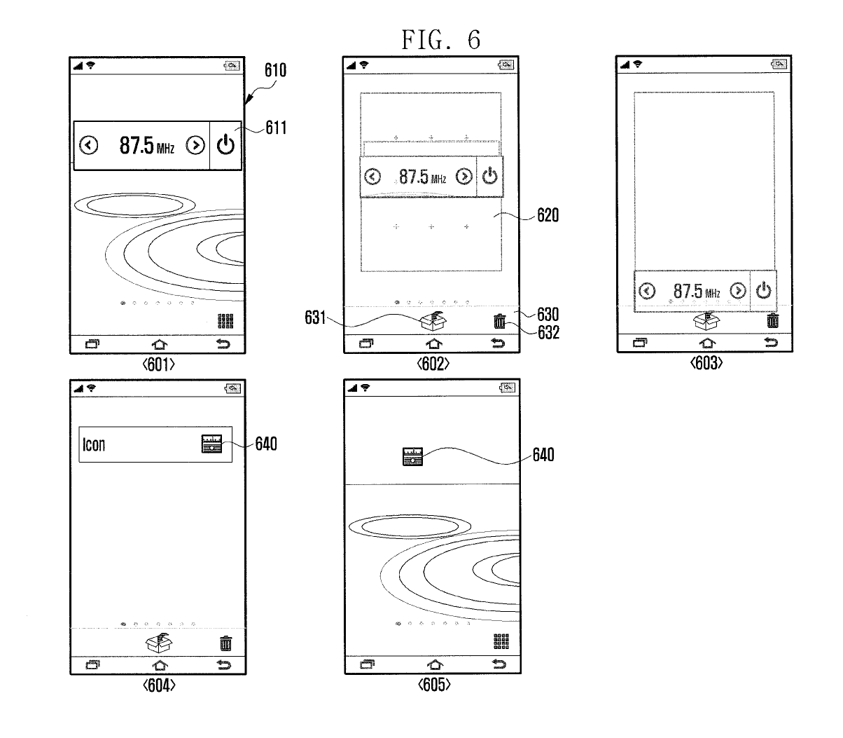

FIG. 6 is a view of a screen for describing an object converting function according to a fourth embodiment of the present disclosure.

Referring to FIG. 6, the touch screen 110 displays a radio app widget 611 corresponding to a radio app on a standby screen 610 as illustrated in screen 601.

A user may press the radio app widget 611 in order to convert the radio app widget 611. Then, the controller 160 detects a touch of selecting the radio app widget 611 and counts a time based on a touch detection time point. When the touch of selecting the radio app widget 611 is maintained for a preset time (for example, 2 seconds) or longer without a change in a position, the controller 160 changes from the standby mode to the object conversion mode. The controller 160 determines the radio app widget 611 as an object conversion target object. In the object conversion mode, the touch screen 110 may be divided in to a display region 620 in which the selected radio app widget 611 is displayed and a menu region 630 in which conversion menu items are displayed as illustrated in screen 602. The menu region 630 may include an object conversion item 631 and a deletion item 632, but is not limited thereto.

When the operation mode is changed to the object conversion mode, the user may drag and move the radio app widget 611 as illustrated in screen 603. The controller 160 detects a movement of a touch on the touch screen 110, and displays the movement of the radio app widget 611 in response to the movement of the touch.

When the controller 160 detects that the radio app widget 611 moves to a position of the conversion item 631, the controller 160 outputs a radio app icon 640 providing different indication information from that of the radio app widget through a selection list as illustrated in screen 604. In the embodiment of the present disclosure, when the portable terminal may support a first radio app icon, a second radio app icon, and a third radio app icon having different types, the selection list including a plurality of icons may be output.

In this state, the user may touch the radio app icon 640. The controller 160 detects an input of the user selecting the radio app icon, changes from the object conversion mode to the standby mode in response to a release of the touch and outputs the radio app icon 640 in the standby screen as illustrated in screen 605. Here, the radio app icon 640 outputs a position of a point at which the radio app widget is output, particularly, a position of a center point of the radio app widget.

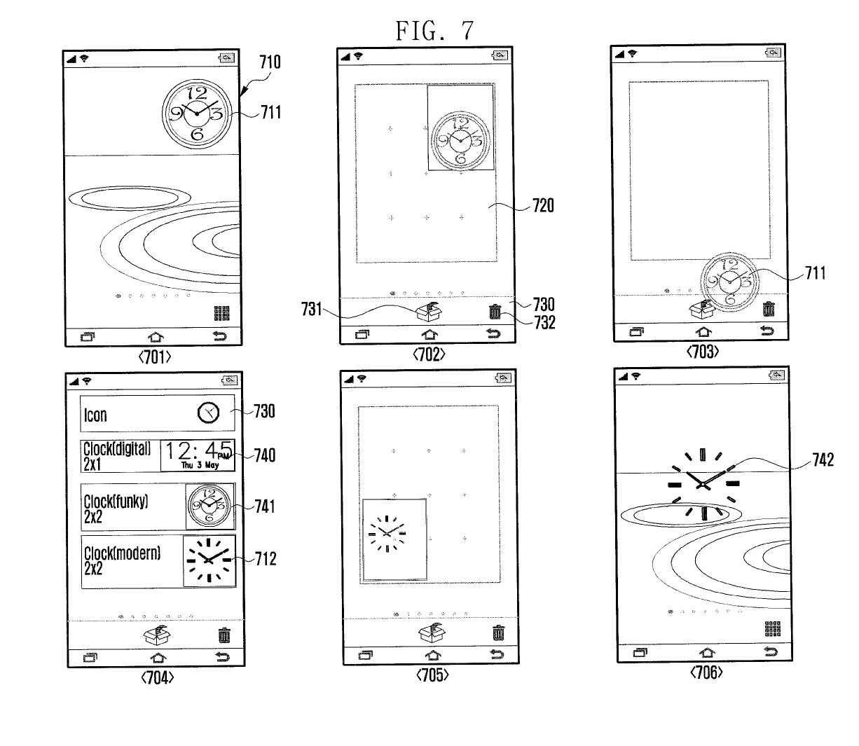

FIG. 7 is a view of a screen for describing an object converting function according to a fifth embodiment of the present disclosure.

Referring to FIG. 7, the touch screen 110 displays a first clock app widget 711 corresponding to a clock app on a standby screen 710 as illustrated in screen 701. The first clock app widget 711 displays time information according to elapse of a time on an image.

In order to convert the first clock app widget 711, the user may select the first clock app widget 711. The controller 160 detects a touch of selecting the first clock app widget 711 and counts a time based on a touch detection time point. When the touch of selecting the first clock app widget 711 is maintained for a preset time (for example, 2 seconds) or longer without a change in a position, the controller 160 from the standby mode to the object conversion mode. The controller 160 determines the first clock app widget as an object conversion target object and outputs an object conversion mode screen image. In the object conversion mode, the touch screen 110 may be divided in to a display region 720 in which the first clock app widget 711 is displayed and a menu region 730 in which conversion menu items are displayed to be displayed as illustrated in screen 702. The menu region 730 may include an object conversion item 731 and a deletion item 732, but is not limited thereto.

The user may drag the first clock app widget 711 to the conversion item 731 as illustrated in screen 703. The controller 160 detects a movement of the touch on the touch screen 110, and displays the movement of the first clock app widget 711 in response to the movement of the touch.

When the controller 160 detects that the first clock app widget 711 moves to the position of the conversion item 731, the controller 160 outputs a selection list of objects having different indication information from that of the first clock app widget. For example, as illustrated in screen 704, the controller 160 may output the selection list including a clock icon 730 corresponding to the clock app, a second clock app widget 740, a third clock app widget 741, and a fourth clock app widget 742 having indication information in a different type from that of the first clock app widget 711, and the like on the screen.

In this state, the user may select the fourth clock app widget 742. Then, the controller 160 detects an input of the user selecting the fourth clock app widget 742, converts the first clock app widget 711 into the fourth clock app widget 742, and displays the converted fourth clock app widget 742 on the display region 720 as illustrated in screen 705. In this case, the controller 160 may display the fourth clock app widget 742 in a preview type in the object conversion mode, but the present disclosure is not limited thereto. In this case, the fourth clock app widget 742 may be output at a position of a point at which the clock icon is output, but is not limited thereto.

In this state, the controller 160 may detect a movement of the touch of the user moving the fourth clock app widget 742. The controller 160 displays a movement of the fourth clock app widget 742 in response to the movement of the touch. When the user releases the touch, the controller 160 changes from the object conversion mode to the standby mode in response to the release of the touch and outputs the fourth clock app widget 742 on the standby screen 710. In this case, the fourth clock app widget 742 may be output on the standby screen 710 based on a point at which the touch is released.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of converting an object in a portable terminal, the method comprising:
displaying a first object corresponding to an application on a standby screen of the portable terminal;
detecting a first touch input of a user selecting the first object;
changing an operating mode of the portable terminal from a standby mode to an object conversion mode if the first touch input is an input requesting entry to an object conversion mode;
detecting a conversion request for a first object in the object conversion mode; and
changing the first object to a second object in response to the conversion request.

2. The method of claim 1, wherein the changing of the second object includes:
displaying a second object having different indication information from indication information of the first object in correspondence with the application in response to the conversion request;
detecting a second touch input for selecting the second object; and
changing the first object to the second object in response to the second touch input and displaying the changed second object.

3. The method of claim 1, wherein the first object and the second object are at least one of an icon, a widget, and an application execution screen image.

4. The method of claim 1, wherein the second object and the first object provides an execution command of a first application, and wherein the second object has at least one of a size of a displayed image, a shape of a displayed image, displayed contents, and an arrangement of indication information different from that of the first object.

5. The method of claim 1, wherein, in the changing of the object converting mode, the screen is divided into a display region in which the first object is output and a menu region in which a conversion function execution command or a deletion function execution command is output in response to the first touch input.

6. The method of claim 1, wherein the detecting of the conversion request for the first object includes:
moving the first object in response to a movement of the first touch input; and
when the movement of the first object is detected at a position of an object conversion menu item, determining the movement of the first object as the conversion request for the first object.

7. The method of claim 1, wherein the displaying of the second object includes displaying the second object in correspondence with a position at which the first object is output.

8. The method of claim 1, wherein the changing of the second object includes:
displaying the second object in a preview type; and
when a third input of the user of releasing the object conversion mode is detected, outputting a second object by applying the release of the object conversion mode.

9. The method of claim 1, further comprising determining a group of objects supportable by the application based on a configuration of the portable terminal

10. A method of converting an object in a portable terminal, the method comprising:
detecting a first touch input of a user for selecting a first object among an icon and one or more widgets corresponding to an application on a standby screen of the portable terminal;
changing an operating mode of the portable terminal from a standby mode to an object conversion mode when the detected first touch input is an input requesting entry to an object conversion mode;
detecting a conversion request for the one object in the object conversion mode; and
changing the first to second object in response to the conversion request.

11. The method of claim 10, wherein the changing of the first object to second object includes:
displaying a selection list including the remaining objects except for the first object in response to the conversion request;
detecting a second touch input of a user selecting the second object in the selection list; and
changing the first object to a second object and displaying the second object in response to the second touch input.

12. The method of claim 10, wherein the changing of the first object to second object includes determining the remaining objects from the application based on a configuration of the portable terminal.

13. A portable terminal comprising:
a touch screen configured to detect a touch input of a user and to provide a user interface for converting an object output on a standby screen; and
a controller configured to control the touch screen to detect a first touch input for a first object displayed corresponding to an application on the touch screen, to change an operating mode of the portable terminal from a standby mode to an object conversion mode when the first touch input is an input requesting entry to the object conversion mode, and to change the first object to a second object in response to a conversion request in a case where the conversion request for the first object is detected in the object conversion mode.

14. The portable terminal of claim 13, wherein the controller controls to display a second object having different indication information from indication information of the first object in correspondence with the app, and when a second touch input of the user selecting the second object is detected, the controller controls to change the first object to the second object in response to the second touch input.

15. The portable terminal of claim 13, wherein the touch screen includes a touch panel and a display unit, and
the display unit is divided into a display region in which an object is displayed and a menu region in which a conversion item and a deletion item are displayed.

16. The portable terminal of claim 14, wherein the display unit displays the second object in a preview type in the object conversion mode.

17. The portable terminal of claim 14, wherein the display unit displays a second object corresponding to a position at which the first object is output under control of the controller.

18. The portable terminal of claim 13, wherein the controller controls to display the first object with at least one of an icon and one or more widgets, and displays the second object with an object different from the first object.

19. The portable terminal of claim 13, wherein the controller displays the second object in a preview type, and when a third input of the user of releasing the object conversion mode is detected, the controller outputs the second object by releasing the object conversion mode.
